(19) United States
(12) Patent Application Publication
(10) Pub. No.: US 2022/0212749 A1
(43) Pub. Date: Jul. 7, 2022

(54) SYNCHRONOUS BRAKING DEVICE FOR FRONT AND REAR WHEELS OF BICYCLES

(71) Applicants: PAO-HSIEN CHENG, TAIPEI CITY (TW); CHUN-SHUO CHENG, TAINAN CITY (TW)

(72) Inventors: PAO-HSIEN CHENG, TAIPEI CITY (TW); CHUN-SHUO CHENG, TAINAN CITY (TW)

(21) Appl. No.: 17/241,208

(22) Filed: Apr. 27, 2021

(30) Foreign Application Priority Data
Jan. 5, 2021 (TW) 110200081

(51) Int. Cl. B62L 3/08

(52) U.S. Cl. CPC B62L 3/08

(57) ABSTRACT

A synchronous braking device for front and rear wheels of bicycles is revealed. A left brake cable and a right brake cable which are operated by a left brake lever and a right brake lever respectively are connected to a synchronous driving integration mechanism. No matter users squeeze the left brake lever, the right brake lever, or both the left and the right brake levers at the same time, a front brake cable and a rear brake cable are driven synchronously. Thereby a brake installed on a front wheel and a brake set on a rear wheel are further driven to brake at the same time. Thereby the rider's safety during riding is ensured.

### BACKGROUND OF THE INVENTION

### Field of the Invention

The present invention relates to a braking device for bicycles, especially to a synchronous braking device for front and rear wheels of bicycles by which brakes installed on the front and the rear wheels are activated to act synchronously and the riding safety is further enhanced.

### Description of Related Art

With the higher living standard, leisure activities and physical fitness have received increasing attention in recent years. Besides a transportation device, a bicycle can also help people work out and build their bodies. Thus riding bicycle in the countryside has become one of the most popular outdoor activities at the moment.

A bicycle brake generally includes a front wheel brake and a rear wheel brake which are controlled by a left brake lever on a left handlebar and a right brake lever on a right handlebar respectively. The left and right brake levers and the front and rear wheel brakes are connected by brake cables. While users squeeze the left brake lever or the right brake lever, the front wheel brake or the rear wheel brake are further operated by the brake cable to act.

When riders intend to brake during riding of the bicycle, certain brake operations may produce safety problems. While riding fast, the user squeezes one brake lever and only the front wheel is locked up. Now the center of gravity of the front part of the bicycle is lowered due to sudden braking of the front wheel. This works together with impact force of the unstopped rear wheel will cause a skid or the rear wheel is barely touching the ground. Thereby the sudden brake makes the bicycle and the rider flip over and causes accidents. If the user only brakes the rear wheel by operating the brake lever on one side, the front wheel of the bicycle is still running quickly and the stopped rear wheel is pulled by the front wheel. Thus the front wheel is moved in a zig-zag manner and this terribly affects a rider's and others' safety. A better and safer way is to brake the front and rear wheels at the same time.

Thus there is room for improvement and there is need to provide various devices by which front wheel braking and rear wheel braking are carried out synchronously for improving the safety of bicycle riders while riding bicycles.

Based on the fact that synchronous braking of the front and rear wheels of the bicycle effectively enhances the bicycle rider's safety, a synchronous braking device for front and rear wheels of bicycles of the present invention is provided.

### SUMMARY OF THE INVENTION

Therefore, it is a primary object of the present invention to provide a synchronous braking device for front and rear wheels of bicycles by which both front and rear brake cables are pulled synchronously so that brakes installed on the front and the rear wheels are driven to act at the same time while a brake lever at either left or right side is operated.

In order to achieve the above object, a synchronous braking device for front and rear wheels of bicycles includes two brake levers, a left brake cable, a right brake cable, a synchronous driving integration mechanism, a front brake cable, and a rear brake cable.

Each of the left brake cable and the right brake cable includes a first joining end and a second joining end which are arranged opposite to each other and connected to one of brake levers and the synchronous driving integration mechanism respectively.

Each of the front brake cable and the rear brake cable is composed of a first connection end and a second connection end disposed opposite to each other. The first connection end of the front brake cable and the first connection end of the rear brake cable are connected to a brake installed on a front wheel and a brake arranged at a rear wheel respectively while both of the second connection ends are connected to the synchronous driving integration mechanism.

At least one of the brake levers is operated to make the left brake cable or/and the right brake cable pull the front brake cable and the rear brake cable synchronously through the synchronous driving integration mechanism. Then the front brake cable and the rear brake cable further drive the brake arranged at the front wheel and the brake disposed on the rear wheel respectively to act on the front and the rear wheels at the same time.

Preferably, the synchronous driving integration mechanism consists of a fastener and a disc body which is provided with two discs arranged coaxially and a gap formed between the two discs. The fastener is fixed between the two discs and across the gap. The left brake cable and the right brake cable are mounted in the gap, wound around an axis of the disc body in a first direction, and connected and fixed to the fastener by the second joining ends. The front brake cable and the rear brake cable are mounted in the gap, wound around the axis of the disc body in a second direction opposite to the first direction, and connected and fixed to the fastener by the second connection ends.

Preferably, the front brake cable and the left brake cable are the same cable. The rear brake cable and the right brake cable are also the same cable.

The present invention has the following advantages.

By the design of the left and the right brake cables connected to the synchronous driving integration mechanism which is connected with both the front and the rear brake cables, no matter bicycle riders operate the left brake lever, the right brake lever, or both the left and the right brake levers at the same time, the front and the rear brake cables are pulled at the same time through synchronous driving of the synchronous driving integration mechanism by the brake lever(s). Thus the front and the rear brake cables further drive brakes installed on the front and the rear wheels at the same time to act on and brake the front and the rear wheels simultaneously. Thereby the riding safety is enhanced.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a schematic drawing showing structure of an embodiment of a synchronous braking device for front and rear wheels of bicycles according to the present invention;

FIG. 2 is an exploded view of an embodiment of a synchronous braking device for front and rear wheels of bicycles according to the present invention;

FIG. 3 is a fully assembled view of an embodiment of a synchronous braking device for front and rear wheels of bicycles according to the present invention;

FIG. 4 is a perspective view of an embodiment of a synchronous braking device for front and rear wheels of bicycles according to the present invention;

FIG. 5 is a schematic drawing showing an embodiment mounted to a bicycle according to the present invention.

### DETAILED DESCRIPTION OF THE PREFERRED EMBODIMENT

In order to learn technical content, features and functions of the present invention more completely and clearly, please refer to the following detailed description with reference to the accompanying figures and reference signs.

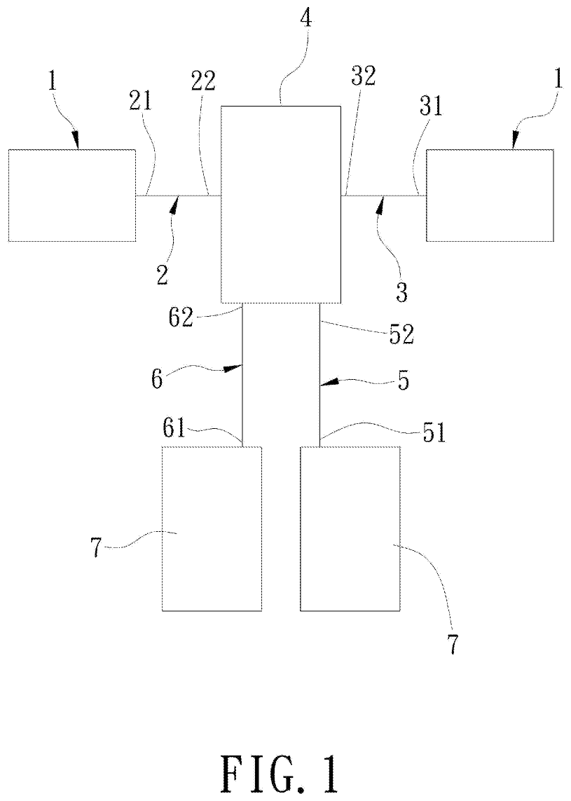

Refer to FIG. 1, a synchronous braking device for front and rear wheels of bicycles according to the present invention includes two brake levers 1 (a left one and a right one), a left brake cable 2, a right brake cable 3, a synchronous driving integration mechanism 4, a front brake cable 5, and a rear brake cable 6.

Each of the left brake cable 2 and the right brake cable 3 includes a first joining end 21, 31 and a second joining end 22, 32 which are arranged opposite to each other and connected to the one of the brake levers 1 correspondingly and the synchronous driving integration mechanism 4 respectively.

As to the front brake cable 5 and the rear brake cable 6, each of them is composed of a first connection end 51, 61 and a second connection end 52, 62 disposed opposite to each other. The first connection end 51 of the front brake cable 5 and the first connection end 61 of the rear brake cable 6 are connected to a brake 7 disposed on a front wheel and a brake 7 arranged at a rear wheel respectively while both of the second connection ends 52, 62 are connected to the synchronous driving integration mechanism 4.

While at least one of the brake levers 1 is operated, the left brake cable 2 or/and the right brake cable 3 is/are activated to drive the front brake cable 5 and the rear brake cable 6 synchronously through the synchronous driving integration mechanism 4. Then the front brake cable 5 and the rear brake cable 6 further drive the brake 7 arranged at the front wheel and the brake 7 disposed on the rear wheel respectively to act at the same time.

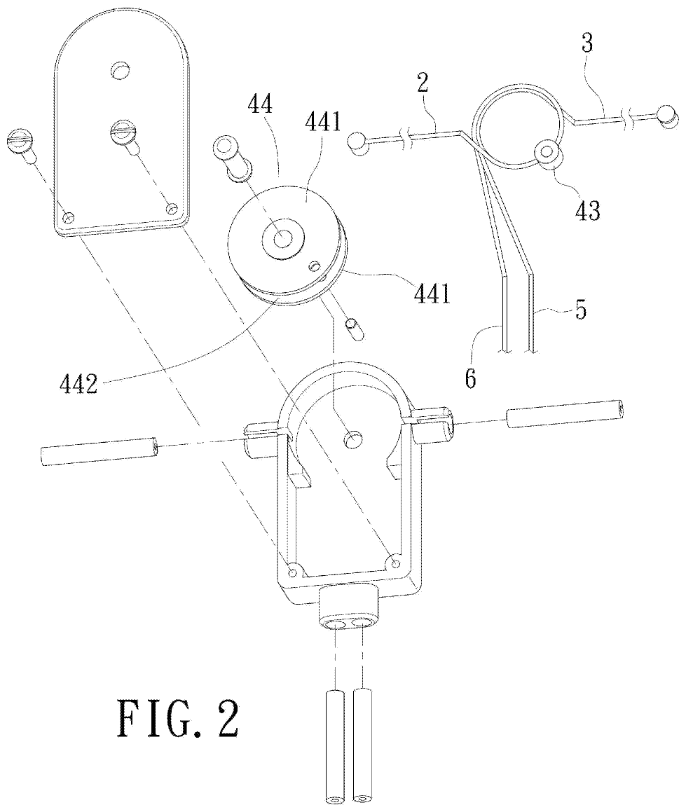

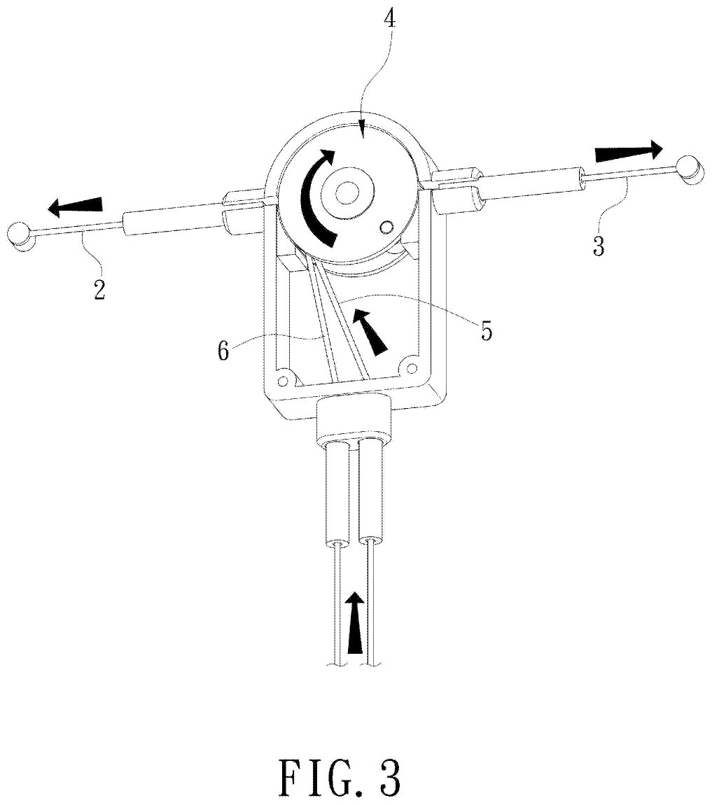

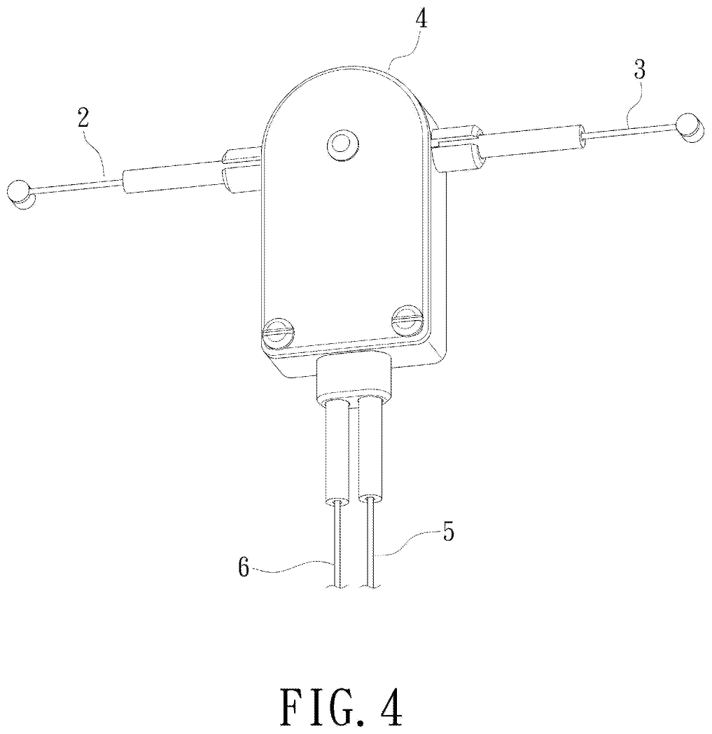

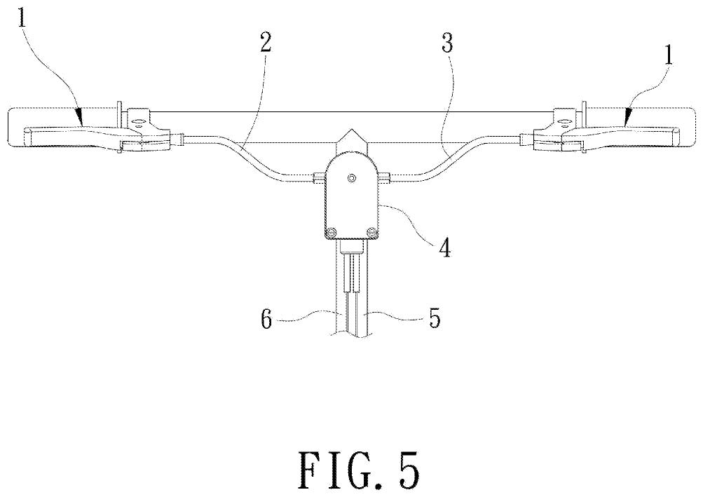

Refer to FIG. 2-5, the synchronous driving integration mechanism 4 consists of a fastener 43 and a disc body 44 which is provided with two discs 441 disposed coaxially and a gap 442 formed between the two discs 441. The fastener 43 is fixed between the two discs 441 and across the gap 442. As shown in FIG. 2 and FIG. 3, the left brake cable 2 and the right brake cable 3 are mounted in the gap 442, wound around an axis of the disc body 44 in a first direction, and connected and fixed to the fastener 43 by the second joining ends 22, 32. The front brake cable 5 and the rear brake cable 6 are mounted in the gap 442, wound around the axis of the disc body 44 in a second direction opposite to the first direction, and connected and fixed to the fastener 43 by the second connection ends 52, 62. In a preferred embodiment, the front brake cable 5 is an extension of the left brake cable 2 and the rear brake cable 6 is an extension of the right brake cable 3. That means not only the front brake cable 5 and the left brake cable 2 are the same cable, the rear brake cable 6 and the right brake cable 3 are also the same cable.

While squeezing the left or/and the right brake lever 1, the left brake cable 2 or/and the right brake cable 3 are also driven to move. Owing to that the second joining ends 22, 32 of the left and the right cables 2, 3 are connected and fixed to the fastener 43 which is fixed between the two discs 441, the left brake cable 2 or/and the right brake cable 3 being driven makes/make the disc body 44 to rotate through the fastener 43. Both the front brake cable 5 and the rear brake cable 6 are wound around the disc body 44 so that the rotation of the disc body 44 drives the front brake cable 5 and the rear brake cable 6 to be pulled at the same time and moved a brake stroke. Thus the brake 7 installed on the front wheel and the brake 7 arranged at the rear wheel are further driven to act on the front wheel and the rear wheel respectively for braking at the same time.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A synchronous braking device for front and rear wheels of bicycles comprising two brake levers, a left brake cable, a right brake cable, a synchronous driving integration mechanism, a front brake cable, and a rear brake cable;
wherein each of the left brake cable and the right brake cable includes a first joining end and a second joining end which are arranged opposite to each other and connected to one of the brake levers correspondingly and the synchronous driving integration mechanism respectively;
wherein each of the front brake cable and the rear brake cable is composed of a first connection end and a second connection end disposed opposite to each other; the first connection end of the front brake cable and the first connection end of the rear brake cable are connected to a brake installed on a front wheel and a brake arranged at a rear wheel respectively while the second connection ends of the front and the rear brake cables are connected to the synchronous driving integration mechanism;
wherein at least one of the brake levers is operated to make the left brake cable or/and the right brake cable pull the front brake cable and the rear brake cable synchronously through the synchronous driving integration mechanism; the front brake cable and the rear brake cable further drive the brake installed on the front wheel and the brake arranged at the rear wheel respectively to act on and brake the front and the rear wheels at the same time.

2. The device as claimed in claim 1, wherein the front brake cable and the left brake cable are the same cable; the rear brake cable and the right brake cable are the same cable.

3. The device as claimed in claim 1, wherein the synchronous driving integration mechanism includes a fastener and a disc body which is provided with two discs arranged coaxially and a gap formed between the two discs; the fastener is fixed between the two discs and across the gap; the left brake cable and the right brake cable are mounted in the gap, wound around an axis of the disc body in a first direction, and connected and fixed to the fastener by the second joining ends; the front brake cable and the rear brake cable are mounted in the gap, wound around the axis of the disc body in a second direction opposite to the first direction, and connected and fixed to the fastener by the second connection ends.

4. The device as claimed in claim 3, wherein the front brake cable and the left brake cable are the same cable; the rear brake cable and the right brake cable are the same cable.
